(19) United States
(12) Patent Application Publication
(10) Pub. No.: US 2015/0228041 A1
(43) Pub. Date: Aug. 13, 2015

(54) CLINICAL TRIAL RECRUITMENT PLATFORM DRIVEN BY MOLECULAR PROFILE

(71) Applicant: CURE FORWARD CORP., Cambridge, MA (US)

(72) Inventors: Martin NALEY, Winchester, MA (US); Andrew BIANKIN, Glasgow (GB); Christopher Richard MOLLOY, Watford (GB)

(21) Appl. No.: 14/176,955

(22) Filed: Feb. 10, 2014

(51) Int. Cl. G06Q 50/22; G06Q 10/06

(52) U.S. Cl. CPC G06Q 50/22; G06Q 10/06

(57) ABSTRACT

Disclosed are platforms, systems, media, and methods for enabling a clinical trial administrator to identify individuals potentially eligible for a clinical trial based at least in part on an individual molecular phenotype, review profiles of identified individuals, and make clinical trial enrollment offers to identified individuals. Also disclosed are platforms, systems, media, and methods for enabling a patient to review and accept or decline clinical trial enrollment offers and identify relevant individuals, clinical trials, and therapies based at least in part on an individual molecular phenotype.

### BACKGROUND OF THE INVENTION

Clinical trials are sets of tests in medical research and drug development that generate safety and efficacy data for health interventions such as medications and other therapies, diagnostics, devices. Clinical trials involve patients with specific health conditions who then benefit from receiving otherwise unavailable treatments.

In the traditional clinical trial recruitment scheme trials are classified by anatomical diagnosis and may include molecular screening criteria. Patients and their physicians attempt to identify appropriate clinical trials based on anatomical diagnosis. Patients apply to trials and are subsequently tested with a drug-specific companion diagnostic test.

### SUMMARY OF THE INVENTION

The current clinical trial recruitment scheme is inadequate and inefficient. For patients, there exists a long-felt and unmet need to have a more active, informed role in the management of their disease. For clinical trial administrators, there exists a long-felt and unmet need to overcome market inefficiency in finding and enrolling patients for molecularly targeted drug trials.

Improved procedures may involve testing patients for molecular profile of their disease and performance of bioinformatic analysis, using continuously curated trial sets including trial inclusion/exclusion criteria, to create lists of available trials for a patient. However, even such improved procedures require each patient to apply to trials that match their molecular phenotype. A cumbersome application process puts burden on treating physician and patient. Moreover, trial lists may be incomplete and some trials already full.

To solve these and other problems of the existing methodologies, described herein are computer-implemented clinical trial exchanges. In the disclosed subject matter, patients are tested for molecular profile of their disease, including drug trial inclusion/exclusion criteria. The individual patients post themselves to a clinical trial exchange. Trial recruiting managers see all available patients that match their recruiting criteria and the trial recruiting managers optionally extend “offers” to individual patients. Each patient sees a list of trials that want them, can solicit expert advice to choose a trial that seems best for them, and optionally accept an offer. Subsequently, the trial sponsor optionally conducts one or more confirmatory application processes (e.g., diagnostic test, review of medical history, entrance interview, etc.) and enrolls the patient.

The platforms, systems, media, and methods disclosed herein offer improvements over existing eHealth applications including providing information architecture that begins with a patient's molecular phenotype rather than anatomical diagnosis and lifting the burden of application from the patient and their treating physicians. Additional advantages include, by way of examples, providing the opportunity for patients to stimulate new clinical trials for targeted therapies and providing links to relevant expert opinions and a rich social community experience.

In one aspect, disclosed herein are non-transitory computer-readable storage media encoded with a computer program including instructions executable by a processor to create an application comprising: a software module configured to receive profiles, each profile comprising a molecular phenotype for an individual; a software module configured to present an interface for allowing a clinical trial administrator to establish a search for the purpose of identifying individuals eligible for enrollment by entering clinical trial patient inclusion and exclusion criteria comprising a molecular phenotype; a software module configured to identify individuals eligible for the clinical trial based on comparison of the profiles and the criteria; a software module configured to present an interface for allowing the clinical trial administrator to receive and review profile information for identified individuals; a software module configured to present an interface for allowing a clinical trial administrator to make clinical trial enrollment offers to identified individuals; a software module configured to present offers made to an individual or their authorized healthcare representative, the individual the subject of the offers; and a software module configured to present an interface for allowing the individual or the authorized healthcare representative to select an offer from among the presented offers. In some embodiments, the application further comprises a database of profiles, each profile comprising a molecular phenotype for an individual. In some embodiments, the molecular phenotype comprises DNA sequence information. In further embodiments, the DNA sequence information comprises two or more genes, two or more molecular variants, and two or more mutations or aberrations. In further embodiments, the DNA sequence information comprises chemical modifications that are measured in normal or diseased tissue. In some embodiments, the molecular phenotype comprises RNA expression information. In some embodiments, the molecular phenotype comprises protein composition information. In some embodiments, the molecular phenotype comprises epigenetic information. In some embodiments, the molecular phenotype comprises biomic information. In some embodiments, the molecular phenotype comprises a multi-analyte survey of molecular information for the patient. In further embodiments, the molecular phenotype comprises a multi-analyte survey including more than 5, 10, 50, or 100 analytes for the patient. In some embodiments, the software module configured to receive profiles imports a molecular phenotype for an individual upon input of a unique code by the individual or the authorized healthcare representative. In further embodiments, the unique code provides transfer of a molecular phenotype between a first storage and a second storage without identity authentication. In some embodiments, making a clinical trial enrollment offer requires a transaction by the clinical trial administrator. In further embodiments, the transaction requires one or more pre-paid credits. In further embodiments, the transaction requires a fee incurred at the time the offer is made or accepted or at the time an enrollment is consummated. In some embodiments, the software module configured to present an interface for allowing a clinical trial administrator to make clinical trial enrollment offers allows the administrator to optionally make an early offer. In some embodiments, the software module configured to present clinical trial enrollment offers accumulates offers made and presents them to the individual after a predetermined period of time. In some embodiments, the software module configured to present an interface for allowing an individual to select an offer allows selection during a predetermined period of time. In some embodiments, the application further comprises a software module configured to present an interface for allowing an individual to identify and communicate with other individuals with a similar profile, including molecular phenotype. In some embodiments, the application further comprises a software module configured to present an interface for allowing an individual to identify one or more treatment options based on their profile, including molecular phenotype. In some embodiments, the application further comprises a software module configured to present an interface for allowing an individual to identify one or more relevant and available clinical trials to which they may apply, the relevance based on their profile, including molecular phenotype. In some embodiments, the application further comprises a software module configured to present an interface for allowing an individual to express interest in participating in a potential clinical trial, the potential clinical trial testing a therapeutic agent for a condition indicated in the individual's profile. In some embodiments, the application further comprises a software module configured to present an interface for allowing an individual to identify and communicate with a medical professional with genomic medicine expertise based on the individual's profile, including molecular phenotype. In some embodiments, the software module configured to present an interface for allowing the clinical trial administrator to receive and review profile information for identified individuals provides profile information for the duration of the search. In some embodiments, the clinical trial enrollment offers comprise an eligibility confirmation process. In some embodiments, the application further comprises a software module configured to conduct e-commerce with an individual, the commerce including goods identified by the application or other individuals based on the individual's profile, the profile comprising a molecular phenotype.

In another aspect, disclosed herein are computer-implemented systems comprising: a digital processing device comprising an operating system configured to perform executable instructions and a memory device; and a computer program including instructions executable by the digital processing device to create an application comprising: a software module configured to receive profiles, each profile comprising a molecular phenotype for an individual; a software module configured to present an interface for allowing a clinical trial administrator to establish a search for the purpose of identifying individuals eligible for enrollment by entering clinical trial patient inclusion and exclusion criteria comprising a molecular phenotype; a software module configured to identify individuals eligible for the clinical trial based on comparison of the profiles and the criteria; a software module configured to present an interface for allowing the clinical trial administrator to receive and review profile information for identified individuals; a software module configured to present an interface for allowing a clinical trial administrator to make clinical trial enrollment offers to identified individuals; a software module configured to present offers made to an individual or their authorized healthcare representative, the individual the subject of the offers; and a software module configured to present an interface for allowing the individual or the authorized healthcare representative to select an offer from among the presented offers. In some embodiments, the application further comprises a database of profiles, each profile comprising a molecular phenotype for an individual. In some embodiments, the molecular phenotype comprises DNA sequence information. In further embodiments, the DNA sequence information comprises two or more genes, two or more variants, and two or more mutations. In further embodiments, the DNA sequence information comprises chemical modifications that are measured in normal or diseased tissue. In some embodiments, the molecular phenotype comprises RNA expression information. In some embodiments, the molecular phenotype comprises protein composition information. In some embodiments, the molecular phenotype comprises epigenetic information. In some embodiments, the molecular phenotype comprises biomic information. In some embodiments, the molecular phenotype comprises a multi-analyte survey of molecular information for the patient. In further embodiments, the molecular phenotype comprises a multi-analyte survey including more than 5, 10, 50, or 100 analytes for the patient. In some embodiments, the software module configured to receive profiles imports a molecular phenotype for an individual upon input of a unique code by the individual or the authorized healthcare representative. In further embodiments, the unique code provides transfer of a molecular phenotype between a first storage and a second storage without identity authentication. In some embodiments, making a clinical trial enrollment offer requires a transaction by the clinical trial administrator. In further embodiments, the transaction requires one or more pre-paid credits. In further embodiments, the transaction requires a fee incurred at the time the offer is made or accepted or at the time an enrollment is consummated. In some embodiments, the software module configured to present an interface for allowing a clinical trial administrator to make clinical trial enrollment offers allows the administrator to optionally make an early offer. In some embodiments, the software module configured to present clinical trial enrollment offers accumulates offers made and presents them to the individual after a predetermined period of time. In some embodiments, the software module configured to present an interface for allowing an individual to select an offer allows selection during a predetermined period of time. In some embodiments, the application further comprises a software module configured to present an interface for allowing an individual to identify and communicate with other individuals with a similar profile, including molecular phenotype. In some embodiments, the application further comprises a software module configured to present an interface for allowing an individual to identify one or more treatment options based on their profile, including molecular phenotype. In some embodiments, the application further comprises a software module configured to present an interface for allowing an individual to identify one or more relevant and available clinical trials to which they may apply, the relevance based on their profile, including molecular phenotype. In some embodiments, the application further comprises a software module configured to present an interface for allowing an individual to express interest in participating in a potential clinical trial, the potential clinical trial testing a therapeutic agent for a condition indicated in the individual's profile. In some embodiments, the application further comprises a software module configured to present an interface for allowing an individual to identify and communicate with a medical professional with genomic medicine expertise based on the individual's profile, including molecular phenotype. In some embodiments, the software module configured to present an interface for allowing the clinical trial administrator to receive and review profile information for identified individuals provides profile information for the duration of the search. In some embodiments, the clinical trial enrollment offers comprise an eligibility confirmation process. In some embodiments, the application further comprises a software module configured to conduct e-commerce with an individual, the commerce including goods identified by the application or other individuals based on the individual's profile, the profile comprising a molecular phenotype.

In another aspect, disclosed herein are computer-implemented methods comprising: receiving, at a computer, a plurality of profiles, each profile comprising a molecular phenotype for an individual; receiving, by the computer, clinical trial patient inclusion and exclusion criteria, the criteria comprising a molecular phenotype, the receipt of the criteria establishing a search for the purpose of identifying individuals eligible for enrollment; identifying, by the computer, individuals eligible for the clinical trial based on comparison of the profiles and the criteria; presenting, by the computer, profile information for identified individuals; receiving, by the computer, one or more clinical trial enrollment offers for identified individuals; presenting, by the computer, the one or more offers received to an individual, the individual the subject of the one or more offers; and receiving, by the computer, a selection from an individual of an offer from among the presented offers. In some embodiments, the molecular phenotype comprises DNA sequence information. In further embodiments, the DNA sequence information comprises two or more genes, two or more variants, and two or more mutations. In further embodiments, the DNA sequence information comprises chemical modifications that are measured in normal or diseased tissue. In some embodiments, the molecular phenotype comprises RNA expression information. In some embodiments, the molecular phenotype comprises protein composition information. In some embodiments, the molecular phenotype comprises epigenetic information. In some embodiments, the molecular phenotype comprises biomic information. In some embodiments, the molecular phenotype comprises a multi-analyte survey of molecular information for the patient. In further embodiments, the molecular phenotype comprises a multi-analyte survey including more than 5, 10, 50, or 100 analytes for the patient. In some embodiments, receiving a profile comprises importing, by the computer, a molecular phenotype for an individual upon input of a unique code. In further embodiments, the unique code provides transfer, by the computer, of a molecular phenotype between a first storage and a second storage without identity authentication. In some embodiments, receiving a clinical trial enrollment offer requires a transaction by the clinical trial administrator. In further embodiments, the transaction requires one or more pre-paid credits. In further embodiments, the transaction requires a fee incurred at the time the offer is made or accepted or at the time an enrollment is consummated. In some embodiments, at least one clinical trial enrollment offer is an early offer. In some embodiments, presenting the one or more offers received to an individual comprises accumulating offers made and presenting them to the individual after a predetermined period of time. In some embodiments, receiving a selection from an individual of an offer from among the presented offers is performed during a predetermined time window. In some embodiments, presenting profile information for identified individuals is performed for the duration of the search. In some embodiments, the clinical trial enrollment offers comprise an eligibility confirmation process.

In another aspect, disclosed herein are non-transitory computer-readable storage media encoded with a computer program including instructions executable by a processor to create an application comprising: a software module configured to allow an individual or their authorized healthcare representative to input a profile, the profile comprising a molecular phenotype for the individual; a software module configured to present one or more clinical trial enrollment offers made to the individual or their authorized healthcare representative, the one or more clinical trial enrollment offers made by clinical trial administrators based on the profile, including the molecular phenotype; and a software module configured to allow the individual or their authorized healthcare representative to select a clinical trial enrollment offer from among the presented one or more clinical trial enrollment offers. In some embodiments, the molecular phenotype comprises DNA sequence information. In further embodiments, the DNA sequence information comprises two or more genes, two or more variants, and two or more mutations. In further embodiments, the DNA sequence information comprises chemical modifications that are measured in normal or diseased tissue. In some embodiments, the molecular phenotype comprises RNA expression information. In some embodiments, the molecular phenotype comprises protein composition information. In some embodiments, the molecular phenotype comprises epigenetic information. In some embodiments, the molecular phenotype comprises biomic information. In some embodiments, the molecular phenotype comprises a multi-analyte survey of molecular information for the patient. In further embodiments, the molecular phenotype comprises a multi-analyte survey including more than 5, 10, 50, or 100 analytes for the patient. In some embodiments, the software module configured to allow an individual or their authorized healthcare representative to input a profile allows import of a molecular phenotype for the individual upon input of a unique code. In further embodiments, the unique code provides transfer of a molecular phenotype between a first storage and a second storage without identity authentication. In some embodiments, at least one clinical trial enrollment offer is an early offer. In some embodiments, the software module configured to present one or more clinical trial enrollment offers made accumulates offers made and presents them after a predetermined period of time. In some embodiments, the software module configured to allow the individual or their authorized healthcare representative to select a clinical trial enrollment offer allows selection during a predetermined period of time. In some embodiments, the application further comprises a software module configured to present an interface for allowing an individual to identify and communicate with other individuals with a similar profile, including molecular phenotype. In some embodiments, the application further comprises a software module configured to present an interface for allowing an individual to identify one or more treatment options based on their profile, including molecular phenotype. In some embodiments, the application further comprises a software module configured to present an interface for allowing an individual to identify one or more relevant and available clinical trials to which they may apply, the relevance based on their profile, including molecular phenotype. In some embodiments, the application further comprises a software module configured to present an interface for allowing an individual to express interest in participating in a potential clinical trial, the potential clinical trial testing a therapeutic agent for a condition indicated in the individual's profile. In some embodiments, the application further comprises a software module configured to present an interface for allowing an individual to identify and communicate with a medical professional with genomic medicine expertise based on the individual's profile, including molecular phenotype. In some embodiments, the clinical trial enrollment offers comprise an eligibility confirmation process.

In another aspect, disclosed herein are computer-implemented systems comprising: a digital processing device comprising an operating system configured to perform executable instructions and a memory device; and a computer program including instructions executable by the digital processing device to create an application comprising: a software module configured to allow an individual or their authorized healthcare representative to input a profile, the profile comprising a molecular phenotype for the individual; a software module configured to present one or more clinical trial enrollment offers made to the individual or their authorized healthcare representative, the one or more clinical trial enrollment offers made by clinical trial administrators based on the profile, including the molecular phenotype; and a software module configured to allow the individual or their authorized healthcare representative to select a clinical trial enrollment offer from among the presented one or more clinical trial enrollment offers.

In another aspect, disclosed herein are non-transitory computer-readable storage media encoded with a computer program including instructions executable by a processor to create an application comprising: a software module configured allow a clinical trial administrator to establish a search for the purpose of identifying individuals eligible for enrollment by entering clinical trial patient inclusion and exclusion criteria comprising a molecular phenotype; a software module configured to allow the clinical trial administrator to identify individuals eligible for the clinical trial based on comparison of the criteria and individual profiles, each profile comprising a molecular phenotype for an individual; a software module configured to allow the clinical trial administrator to make clinical trial enrollment offers to identified individuals; and a software module configured to receive a selection of an offer from each individual or their authorized healthcare representative, the individual the subject of at least one offer. In some embodiments, the molecular phenotype comprises DNA sequence information. In further embodiments, the DNA sequence information comprises two or more genes, two or more variants, and two or more mutations. In some embodiments, the molecular phenotype comprises RNA expression information. In some embodiments, the molecular phenotype comprises protein composition information. In some embodiments, the molecular phenotype comprises epigenetic information. In some embodiments, the molecular phenotype comprises biomic information. In some embodiments, the molecular phenotype comprises a multi-analyte survey of molecular information for the patient. In further embodiments, the molecular phenotype comprises a multi-analyte survey including more than 5, 10, 50, or 100 analytes for the patient. In some embodiments, the molecular phenotype for an individual was imported upon input of a unique code. In further embodiments, the unique code provides transfer of a molecular phenotype between a first storage and a second storage without identity authentication. In some embodiments, making a clinical trial enrollment offer requires a transaction by the clinical trial administrator. In further embodiments, the transaction requires one or more pre-paid credits. In further embodiments, the transaction requires a fee incurred at the time the offer is made or accepted or at the time an enrollment is consummated. In some embodiments, the software module configured to allow the clinical trial administrator to make clinical trial enrollment offers allows the administrator to optionally make an early offer. In some embodiments, the software module configured to allow the clinical trial administrator to identify individuals eligible for the clinical trial allows identification for the duration of the search. In some embodiments, the clinical trial enrollment offers comprise an eligibility confirmation process.

In another aspect, disclosed herein are computer-implemented systems comprising: a digital processing device comprising an operating system configured to perform executable instructions and a memory device; and a computer program including instructions executable by the digital processing device to create an application comprising: a software module configured allow a clinical trial administrator to establish a search for the purpose of identifying individuals eligible for enrollment by entering clinical trial patient inclusion and exclusion criteria comprising a molecular phenotype; a software module configured to allow the clinical trial administrator to identify individuals eligible for the clinical trial based on comparison of the criteria and individual profiles, each profile comprising a molecular phenotype for an individual; a software module configured to allow the clinical trial administrator to make clinical trial enrollment offers to identified individuals; and a software module configured to receive a selection of an offer from each individual or their authorized healthcare representative, the individual the subject of at least one offer.

In another aspect, disclosed herein are non-transitory computer-readable storage media encoded with a computer program including instructions executable by a processor to create an application comprising: a database of drug information and clinical trial information; a software module configured to receive a profile for an individual, the profile comprising a molecular phenotype for the individual; a software module configured to match the individual to one or more drugs based on the individual's molecular phenotype; a software module configured to present an interface for allowing the individual to review the degree of existing medical evidence supporting use of each matched drug as a therapy for one or more conditions; a software module configured to present an interface for allowing the individual to volunteer as a subject in a proposed clinical trial for a matched drug where insufficient medical evidence exists to support use of the drug as a therapy for a condition associated with the individual's molecular phenotype; a software module configured to assemble cohorts of individuals volunteering as subjects in a proposed clinical trial for a drug; and a software module configured to present an interface for allowing a drug product manager to review the cohorts of individuals volunteering as subjects in a proposed clinical trial for a drug managed by the drug product manager. In some embodiments, the degree of medical evidence supporting use of a drug as a therapy for a condition comprises one or more of: demonstrated effective through a randomized clinical trial, demonstrated effective in observational study, open clinical trial underway, available through formulation access program, and demonstrated ineffective. In some embodiments, the application further comprises a software module configured to transmit an alert to the drug product manager when a cohort of individuals is assembled. In some embodiments, the application further comprises a software module configured to process a financial transaction with a sponsor of a proposed clinical trial if the proposed trial is undertaken with an assembled cohort.

In another aspect, disclosed herein are computer-implemented systems comprising: a digital processing device comprising an operating system configured to perform executable instructions and a memory device; and a computer program including instructions executable by the digital processing device to create an application comprising: a database of drug information and clinical trial information; a software module configured to receive a profile for an individual, the profile comprising a molecular phenotype for the individual; a software module configured to match the individual to one or more drugs based on the individual's molecular phenotype; a software module configured to present an interface for allowing the individual to review the degree of existing medical evidence supporting use of each matched drug as a therapy for one or more conditions; a software module configured to present an interface for allowing the individual to volunteer as a subject in a proposed clinical trial for a matched drug where insufficient medical evidence exists to support use of the drug as a therapy for a condition associated with the individual's molecular phenotype; a software module configured to assemble cohorts of individuals volunteering as subjects in a proposed clinical trial for a drug; and a software module configured to present an interface for allowing a drug product manager to review the cohorts of individuals volunteering as subjects in a proposed clinical trial for a drug managed by the drug product manager. In some embodiments, the degree of medical evidence supporting use of a drug as a therapy for a condition comprises one or more of: demonstrated effective through a randomized clinical trial, demonstrated effective in observational study, open clinical trial underway, available through formulation access program, and demonstrated ineffective. In some embodiments, the application further comprises a software module configured to transmit an alert to the drug product manager when a cohort of individuals is assembled. In some embodiments, the application further comprises a software module configured to process a financial transaction with a sponsor of a proposed clinical trial if the proposed trial is undertaken with an assembled cohort.

### BRIEF DESCRIPTION OF THE DRAWINGS

FIG. 1 shows a non-limiting example of a patient interface; in this case, a patient interface providing an overview of services offered.

FIG. 2 shows a non-limiting example of a patient interface; in this case, a patient interface providing a tool for the patient to understand and explore their molecular phenotype.

FIG. 3 shows a non-limiting example of a patient interface; in this case, a patient interface for reviewing clinical trial enrollment offers.

FIG. 4 shows a non-limiting example of a patient interface; in this case, a patient interface for identifying other similar individuals for networking based at least in part on molecular phenotype.

FIG. 5 shows a non-limiting example of a patient interface; in this case, a patient interface providing access to available networking resources.

FIG. 6 shows a non-limiting example of a patient interface; in this case, a patient interface providing a social network dashboard including access to networking resources.

FIG. 7 shows a non-limiting example of a clinical trial administrator interface; in this case, an administrator interface providing an information dashboard.

FIG. 8 shows a non-limiting example of a clinical trial administrator interface; in this case, an administrator interface providing a tool for configuring a search for individuals potentially eligible for a clinical trial.

FIG. 9 shows a non-limiting example of a clinical trial administrator interface; in this case, an administrator interface for presenting search results.

FIG. 10 shows a non-limiting example of a clinical trial administrator interface; in this case, an administrator interface for reviewing profile details for an individual.

FIG. 11 shows a non-limiting example of a patient interface; in this case, a patient interface for reviewing allowing the patient to review the degree of existing medical evidence supporting use of a matched drug as a therapy for one or more conditions.

### DETAILED DESCRIPTION OF THE INVENTION

Data from the Cancer Genome Atlas project indicates that 127 genes are implicated in driving 12 cancer types, with about 200-400 total explained variants across 12 types of cancer. Each mutation could be seen in many types of cancer. Existing clinical trial recruitment methodologies fail to adequately structure information around the molecular phenotype of individual patients, instead focusing on anatomical diagnosis, such as type of cancer. Moreover, existing methodologies place the burden of identifying clinical trials and applying for participation on the individual patients, their families, and their treating physicians.

Described herein, in certain embodiments, are non-transitory computer-readable storage media encoded with a computer program including instructions executable by a processor to create an application comprising: a software module configured to receive profiles, each profile comprising a molecular phenotype for an individual; a software module configured to present an interface for allowing a clinical trial administrator to establish a search for the purpose of identifying individuals eligible for enrollment by entering clinical trial patient inclusion and exclusion criteria comprising a molecular phenotype; a software module configured to identify individuals eligible for the clinical trial based on comparison of the profiles and the criteria; a software module configured to present an interface for allowing the clinical trial administrator to receive and review profile information for identified individuals; a software module configured to present an interface for allowing a clinical trial administrator to make clinical trial enrollment offers to identified individuals; a software module configured to present offers made to an individual or their authorized healthcare representative, the individual the subject of the offers; and a software module configured to present an interface for allowing the individual or the authorized healthcare representative to select an offer from among the presented offers.

Also described herein, in certain embodiments, are computer-implemented systems comprising: a digital processing device comprising an operating system configured to perform executable instructions and a memory device; and a computer program including instructions executable by the digital processing device to create an application comprising: a software module configured to receive profiles, each profile comprising a molecular phenotype for an individual; a software module configured to present an interface for allowing a clinical trial administrator to establish a search for the purpose of identifying individuals eligible for enrollment by entering clinical trial patient inclusion and exclusion criteria comprising a molecular phenotype; a software module configured to identify individuals eligible for the clinical trial based on comparison of the profiles and the criteria; a software module configured to present an interface for allowing the clinical trial administrator to receive and review profile information for identified individuals; a software module configured to present an interface for allowing a clinical trial administrator to make clinical trial enrollment offers to identified individuals; a software module configured to present offers made to an individual or their authorized healthcare representative, the individual the subject of the offers; and a software module configured to present an interface for allowing the individual or the authorized healthcare representative to select an offer from among the presented offers.

Also described herein, in certain embodiments, are computer-implemented methods comprising: receiving, at a computer, a plurality of profiles, each profile comprising a molecular phenotype for an individual; receiving, by the computer, clinical trial patient inclusion and exclusion criteria, the criteria comprising a molecular phenotype, the receipt of the criteria establishing a search for the purpose of identifying individuals eligible for enrollment; identifying, by the computer, individuals eligible for the clinical trial based on comparison of the profiles and the criteria; presenting, by the computer, profile information for identified individuals; receiving, by the computer, one or more clinical trial enrollment offers for identified individuals; presenting, by the computer, the one or more offers received to an individual, the individual the subject of the one or more offers; and receiving, by the computer, a selection from an individual of an offer from among the presented offers.

Also described herein, in certain embodiments, are non-transitory computer-readable storage media encoded with a computer program including instructions executable by a processor to create an application comprising: a software module configured to allow an individual or their authorized healthcare representative to input a profile, the profile comprising a molecular phenotype for the individual; a software module configured to present one or more clinical trial enrollment offers made to the individual or their authorized healthcare representative, the one or more clinical trial enrollment offers made by clinical trial administrators based on the profile, including the molecular phenotype; and a software module configured to allow the individual or their authorized healthcare representative to select a clinical trial enrollment offer from among the presented one or more clinical trial enrollment offers.

Also described herein, in certain embodiments, are computer-implemented systems comprising: a digital processing device comprising an operating system configured to perform executable instructions and a memory device; and a computer program including instructions executable by the digital processing device to create an application comprising: a software module configured to allow an individual or their authorized healthcare representative to input a profile, the profile comprising a molecular phenotype for the individual; a software module configured to present one or more clinical trial enrollment offers made to the individual or their authorized healthcare representative, the one or more clinical trial enrollment offers made by clinical trial administrators based on the profile, including the molecular phenotype; and a software module configured to allow the individual or their authorized healthcare representative to select a clinical trial enrollment offer from among the presented one or more clinical trial enrollment offers.

Also described herein, in certain embodiments, are non-transitory computer-readable storage media encoded with a computer program including instructions executable by a processor to create an application comprising: a software module configured allow a clinical trial administrator to establish a search for the purpose of identifying individuals eligible for enrollment by entering clinical trial patient inclusion and exclusion criteria comprising a molecular phenotype; a software module configured to allow the clinical trial administrator to identify individuals eligible for the clinical trial based on comparison of the criteria and individual profiles, each profile comprising a molecular phenotype for an individual; a software module configured to allow the clinical trial administrator to make clinical trial enrollment offers to identified individuals; and a software module configured to receive a selection of an offer from each individual or their authorized healthcare representative, the individual the subject of at least one offer.

Also described herein, in certain embodiments, are computer-implemented systems comprising: a digital processing device comprising an operating system configured to perform executable instructions and a memory device; and a computer program including instructions executable by the digital processing device to create an application comprising: a software module configured allow a clinical trial administrator to establish a search for the purpose of identifying individuals eligible for enrollment by entering clinical trial patient inclusion and exclusion criteria comprising a molecular phenotype; a software module configured to allow the clinical trial administrator to identify individuals eligible for the clinical trial based on comparison of the criteria and individual profiles, each profile comprising a molecular phenotype for an individual; a software module configured to allow the clinical trial administrator to make clinical trial enrollment offers to identified individuals; and a software module configured to receive a selection of an offer from each individual or their authorized healthcare representative, the individual the subject of at least one offer.

Also described herein, in certain embodiments, are non-transitory computer-readable storage media encoded with a computer program including instructions executable by a processor to create an application comprising: a database of drug information and clinical trial information; a software module configured to receive a profile for an individual, the profile comprising a molecular phenotype for the individual; a software module configured to match the individual to one or more drugs based on the individual's molecular phenotype; a software module configured to present an interface for allowing the individual to review the degree of existing medical evidence supporting use of each matched drug as a therapy for one or more conditions; a software module configured to present an interface for allowing the individual to volunteer as a subject in a proposed clinical trial for a matched drug where insufficient medical evidence exists to support use of the drug as a therapy for a condition associated with the individual's molecular phenotype; a software module configured to assemble cohorts of individuals volunteering as subjects in a proposed clinical trial for a drug; and a software module configured to present an interface for allowing a drug product manager to review the cohorts of individuals volunteering as subjects in a proposed clinical trial for a drug managed by the drug product manager.

Also described herein, in certain embodiments, are computer-implemented systems comprising: a digital processing device comprising an operating system configured to perform executable instructions and a memory device; and a computer program including instructions executable by the digital processing device to create an application comprising: a database of drug information and clinical trial information; a software module configured to receive a profile for an individual, the profile comprising a molecular phenotype for the individual; a software module configured to match the individual to one or more drugs based on the individual's molecular phenotype; a software module configured to present an interface for allowing the individual to review the degree of existing medical evidence supporting use of each matched drug as a therapy for one or more conditions; a software module configured to present an interface for allowing the individual to volunteer as a subject in a proposed clinical trial for a matched drug where insufficient medical evidence exists to support use of the drug as a therapy for a condition associated with the individual's molecular phenotype; a software module configured to assemble cohorts of individuals volunteering as subjects in a proposed clinical trial for a drug; and a software module configured to present an interface for allowing a drug product manager to review the cohorts of individuals volunteering as subjects in a proposed clinical trial for a drug managed by the drug product manager.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Clinical Trial

In some embodiments, the platforms, systems, media, and methods described herein perform or facilitate recruitment of individuals for clinical trials. In some embodiments, the platforms, systems, media, and methods described herein allow individuals to volunteer as a subject in a proposed clinical trial where insufficient medical evidence exists to support use of the drug as a therapy for a particular condition. In further embodiments, the platforms, systems, media, and methods described herein assemble cohorts of individuals volunteering as subjects in a proposed clinical trial for a therapy.

Clinical trials often involve patients with specific health conditions who seek otherwise unavailable treatments. In light of the disclosure provide herein, those of skill in the art will recognize that clinical trials are prospective biomedical or behavioral research studies of human subjects that are designed to answer specific questions about biomedical or behavioral interventions and generating safety and efficacy data. Clinical trials are conducted only after satisfactory information has been gathered that satisfies regulatory standards for safeguarding human welfare. During a clinical trial, administrators recruit patients with the predetermined characteristics, evaluate the patients, administer one or more treatments, and collect data on the patients' health for a defined time period. Those of skill in the art will also recognize that a clinical trial is typically organized and funded by a sponsor, which may be a governmental organization or a pharmaceutical, biotechnology, or medical device company.

Many types of clinical trials are compatible with the platforms, systems, media, and methods described herein. For example, in various embodiments, a suitable clinical trial is for one or more novel therapies or treatments, vaccines, drugs or other medicines including biologics, medical devices, diagnostics, or new ways of using known interventions. In some embodiments, a suitable clinical trial is an observational study or an interventional study. In some embodiments, a suitable clinical trial is a prevention trial, a screening trial, a diagnostic trial, a treatment trial, a quality of life trial, a compassionate use trial, or a combination thereof. In some embodiments, a suitable clinical trial is any human clinical trial including a phase 0, a phase 1, a phase 2, a phase 3, or a phase 4 trial.

In some suitable clinical trials, a trial administrator specifies inclusion and exclusion criteria for participation in the study. In light of the disclosure herein, those of skill in the art will recognize that inclusion criteria are characteristics that prospective subjects must have if they are to be included in the study, while exclusion criteria are those characteristics that disqualify prospective subjects from inclusion in the study. In various suitable clinical trials, inclusion and exclusion criteria include factors such as age, sex, race, ethnicity, type and stage of disease, the subject's previous treatment history, and the presence or absence of other medical, psychosocial, or emotional conditions. In particular suitable clinical trials, inclusion and exclusion criteria comprise molecular phenotype information.

### Individual Profile Including Molecular Phenotype

In some embodiments, the platforms, systems, media, and methods described herein include a plurality of individual profiles, or use of the same. In further embodiments, the plurality of individual profiles comprises a database of profiles. In some embodiments, the platforms, systems, media, and methods described herein include features for receiving profiles comprising a molecular phenotype for an individual, identifying individuals eligible for a clinical trial based on profiles comprising a molecular phenotype, and allowing clinical trial administrators to review profiles for identified patients.

In some embodiments, a profile is associated with, and includes information describing, a particular individual patient. Many types of information are suitable for inclusion in a profile for an individual. In various embodiments, a profile includes, by way of non-limiting examples, current disease, cancer type, cancer stage, diagnosis date, comorbidities, therapies completed or attempted, health history, previous cancers (including type, stage, date, therapies—for each prior bout), prior clinical trial participation, smoking history, name, location, date of birth, marital status, children, and photographs.

In some embodiments, an individual profile includes a molecular phenotype. As used herein, “molecular phenotype” means one or more characteristics of normal or diseased tissue including information pertaining to DNA, RNA, amino acids, lipids, carbohydrates, proteins, and combinations thereof, including variants, chemical modifications, and aberrations thereof, that confer clinical utility or actionability that guides clinical decision-making or clinical trial eligibility. A molecular phenotype described herein suitably includes a wide variety of information. For example, in some embodiments, a molecular phenotype comprises biomolecular sequence information. In further embodiments, a molecular phenotype comprises DNA sequence information. In still further embodiments, the DNA sequence information comprises a plurality of genes. For example, in various embodiments, the DNA sequence information comprises about 2, 3, 4, 5, 6, 7, 8, 9, 10, 20, 30, 40, 50, 60, 70, 80, 90, 100, 200, 300, 400, 500, 600, 700, 800, 900, 1000, 10000, 11000, 12000, 13000, 14000, 15000, 16000, 17000, 18000, 19000, 20000, or 21000 genes, including increments therein. In some embodiments, a molecular phenotype comprises DNA sequence information including a plurality of molecular variants, mutations (e.g., substitution, insertion, deletion, frame shift, etc.), and/or aberrations. In some embodiments, a molecular phenotype comprises DNA sequence information including chemical modifications that are measured in normal or diseased tissue.

In some embodiments, a molecular phenotype comprises RNA expression information. In other embodiments, a molecular phenotype comprises protein composition information. In other embodiments, a molecular phenotype comprises epigenetic information. In yet other embodiments, a molecular phenotype comprises biomic information. In some embodiments, molecular phenotype comprises a combination of one or more of: DNA sequence information, RNA expression information, protein composition information, epigenetic information, and biomic information. In some embodiments, a molecular phenotype comprises a multi-analyte survey of molecular information for the patient. For example, in various embodiments, a molecular phenotype comprises a multi-analyte survey including more than 2, 3, 4, 5, 6, 7, 8, 9, 10, 20, 30, 40, 50, 60, 70, 80, 90, 100, 200, 300, 400, 500 or more analytes for the patient, including increments therein.

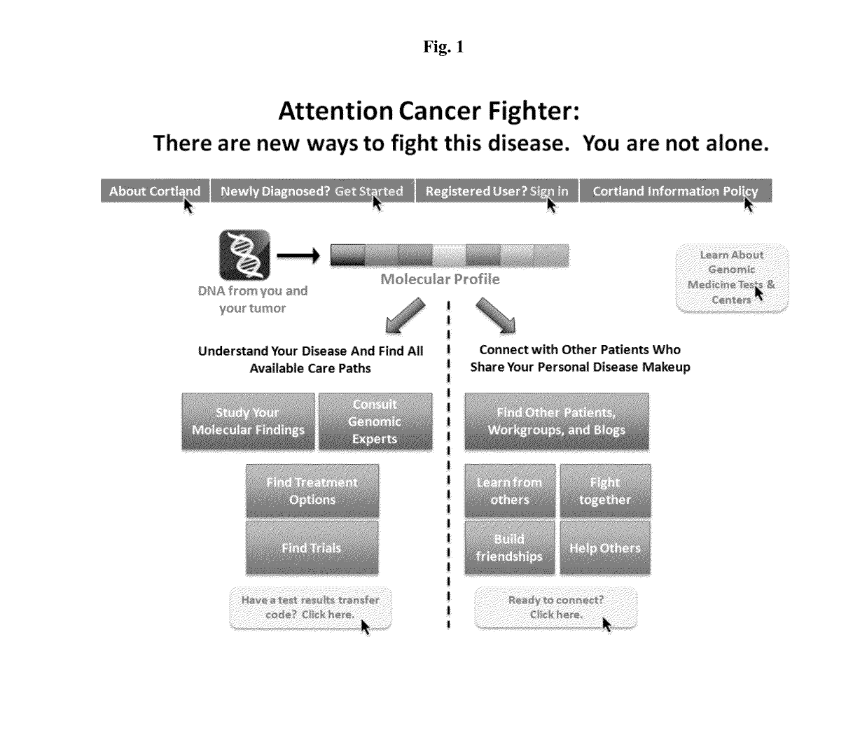

Referring to FIG. 1, in a particular embodiment, the platforms, systems, media, and methods described herein include a patient interface providing tools for providing the individual patient with an overview of, and access to, a suite of services based on their profile including their particular molecular phenotype. In this embodiment, a patient is provided with an overview demonstrating two major applications of their profile, which in this case comprises DNA information. First, in this embodiment, a profile is used to provide information on the patient's disease and available care paths including, for example, study molecular findings, consult a genomic expert, find treatment options, and find clinical trials. In this embodiment, a patient is also provided with an option to transfer new information, obtained via medical tests, to their profile. Second, in this embodiment, a profile is used to allow the patient to connect with other patients who share a similar profile including, for example, finding other patients, workgroups, and blogs, and networking to learn from others, fight disease with others, help others, and build friendships.

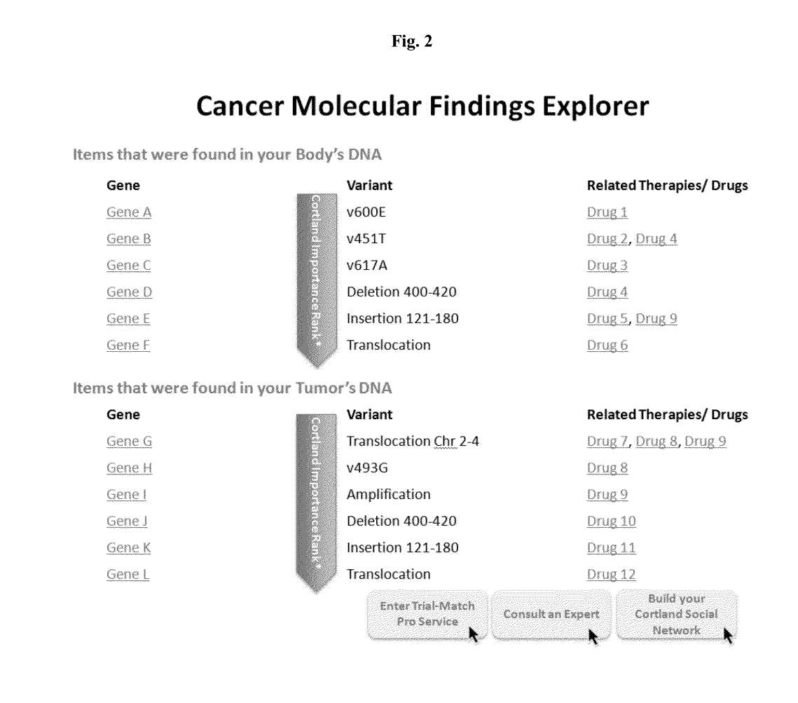

Referring to FIG. 2, in a particular embodiment, the platforms, systems, media, and methods described herein include a patient interface providing tools for allowing the individual patient to review, understand, and explore information describing their particular molecular phenotype, which in this case comprises DNA information. In this embodiment, the patient is provided with information pertaining to genes associated with DNA from their non-tumor and tumor tissues. Further in this embodiment, the patient is provided with one or more variants for each gene (e.g., mutation, etc.). Still further in this embodiment, the patient is provided with one or more related therapies for each gene/variant pair.

In some embodiments, the molecular phenotype aspect of a patient's profile is determined by medical diagnostic testing. In further embodiments, the diagnostic testing is performed at qualified facility participating in the platforms, systems, media, and methods described herein. In some embodiments, a patient manually uploads the results of medical diagnostic testing to enhance or complete their profile. In other embodiments, a patient inputs a unique code provided by a diagnostic testing facility participating in the platforms, systems, media, and methods described herein. In further embodiments, the unique code provides transfer of a molecular phenotype between a first storage at the testing facility and a second storage at the platform described herein without identity authentication, e.g., without requiring a username, email address, or other credentials that affirmatively identify the patient.

### Clinical Trial Enrollment Offers

In some embodiments, the platforms, systems, media, and methods described herein include clinical trial enrollment offers (e.g., invitations, presentations of opportunity, etc.), or use of the same. In some embodiments, the platforms, systems, media, and methods described herein include features for allowing a clinical trial administrator to make clinical trial enrollment offers to individuals identified based on their profile including molecular phenotype. Moreover, in some embodiments, the platforms, systems, media, and methods described herein include features for presenting clinical trial enrollment offers made to an individual and allowing the individual to select a clinical trial enrollment offer. In an exemplary workflow, a clinical trial administrator optionally conducts and manages searches for patients potentially suitable for one or more clinical trials, reviews the profiles of identified patients, and optionally extends recruitment offers to none, one, or more of the identified individuals.

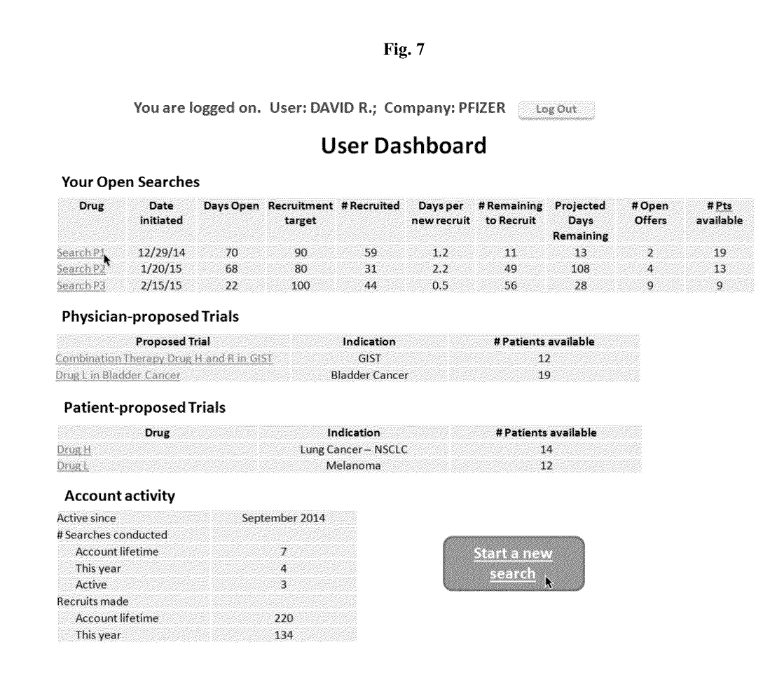

Referring to FIG. 7, in a particular embodiment, the platforms, systems, media, and methods described herein include a clinical trial administrator interface providing an information dashboard presenting searches, trials, and account activity. In this embodiment, the clinical trial administrator interface includes a list of open searches that the administrator has conducted for individuals suitable for a particular clinical trial. For each search, the administrator is presented with search information including, by way of non-limiting examples, drug under investigation, days the search has been open, numeric recruitment target, number of individuals recruited, days per new recruit (an indicator of recruiting velocity), number remaining to recruit, projected days remaining to complete recruitment target, number of open offers (offers made to individuals but not yet accepted), and number of patients available. Further, in this embodiment, the clinical trial administrator interface includes lists of clinical trials proposed by others including those proposed by physicians and those proposed by patients. In this embodiment, the clinical trial administrator interface includes administrator account activity information including, for example, number of searches conducted (over various time periods) and number of recruits made (over various time periods).

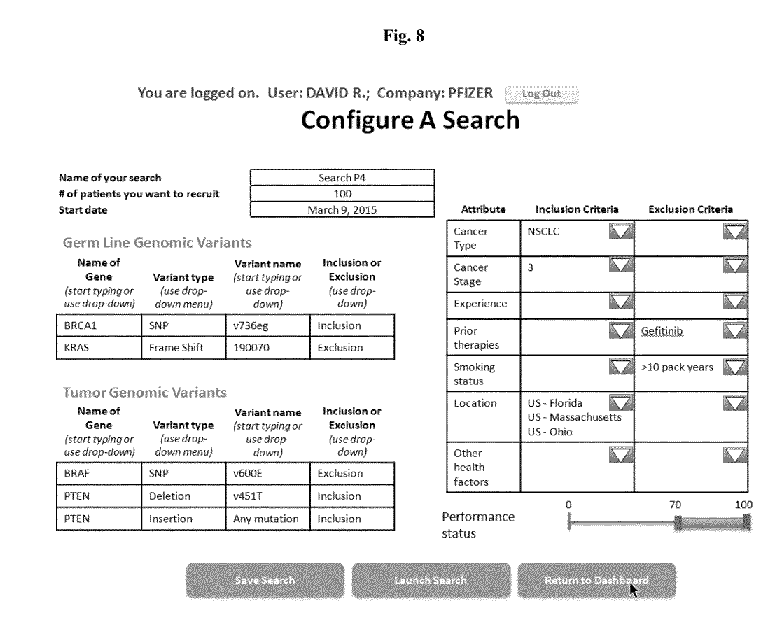

Referring to FIG. 8, in a particular embodiment, the platforms, systems, media, and methods described herein include a clinical trial administrator interface providing tools for configuring a search for individuals potentially eligible for a clinical trial. In this embodiment, the clinical trial administrator interface includes features to allow the administrator to name a search, indicate a numeric recruitment target, and enter a start date for the search. Further, in this embodiment, the clinical trial administrator interface includes tools for the administrator to configure search parameters such as germ line genomic variants and tumor genomic variants as well as individual inclusion and exclusion criteria for each of a number of patient attributes. By way of example, with regard to germ line and tumor genomic variants, an administrator optionally configures the name of the gene, a variant type, a variant name, and whether the variant is an inclusion or an exclusion factor.

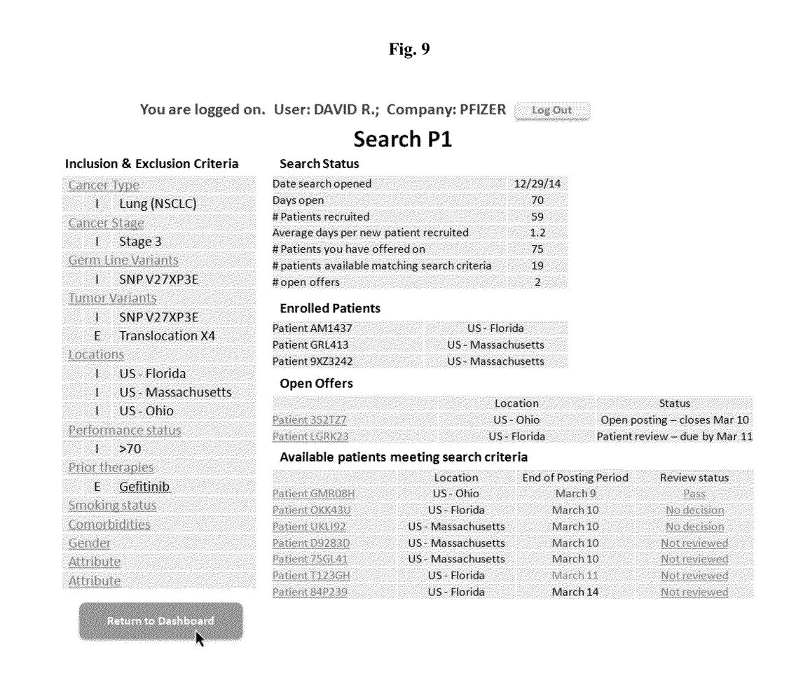

Referring to FIG. 9, in a particular embodiment, the platforms, systems, media, and methods described herein include a clinical trial administrator interface for presenting results of a search for individuals potentially eligible for a clinical trial. In this embodiment, the clinical trial administrator interface includes a reminder of the configured inclusion and exclusion criteria for the search. Further, in this embodiment, the clinical trial administrator interface includes lists of several types of patients including, by way of non-limiting examples, enrolled patients, patients to whom offers have been extended (including status, e.g., offer date, patient review date, etc.), and available patients meeting the search criteria (including status, e.g., passed on offer, no decision on offer, not reviewed offer, etc.). For each patient an identifier and a location are provided. In this embodiment, from the clinical trial administrator interface, an administrator optionally clicks the identifier of a particular patient to review their profile.

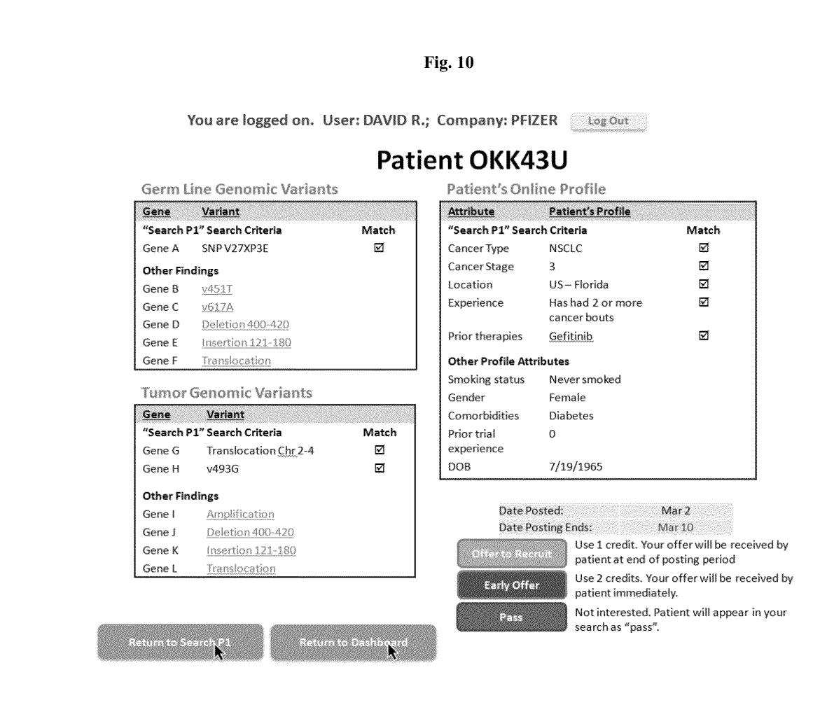

Referring to FIG. 10, in a particular embodiment, the platforms, systems, media, and methods described herein include a clinical trial administrator interface for reviewing the profile of an individual potentially eligible for a clinical trial. In this embodiment, the clinical trial administrator interface allows the administrator to review, for example, the patient's cancer type, cancer stage, residential location, prior therapeutic experience, prior therapies, prior clinical trial experience, smoking status, gender, comorbidities, and date of birth. Further, in this embodiment, the clinical trial administrator interface allows the administrator to review aspects of the patient's molecular phenotype including germ line genomic variants and tumor genomic variants (including gene, mutation, etc.).

Continuing to refer to FIG. 10, in this embodiment, the interface includes features for optionally 1) making an offer to recruit the individual to the clinical trial, 2) making an early offer to the individual, or 3) passing on recruitment of the individual. In this embodiment, making an offer or an early offer requires credits. In some embodiments, the credits represent pre-paid units obtained by the administrator by conducting a financial transaction. In further embodiments, the financial transaction is a payment to the provider of the clinical trial recruiting platform. In other embodiments, the financial transaction is a donation, for example, a donation to a disease related organization. In some embodiments, an early offer is received by the patient immediately, whereas an offer is received by the patient at the end of a pre-determined posting period. In further embodiments, an early offer requires more credits than an offer. In still further embodiments, an early offer requires 1, 2, 3, 4, 5, 6, 7, 8, 9, 10 or more times the credits required for an offer. In this embodiment, an early offer requires 2 credits whereas an offer requires 1 credit.

Many methods of payment are suitable for an administrator to obtain credits. In various embodiments, suitable methods of payment include, by way of non-limiting examples, credit, debit, electronic funds transfer, wire transfer, online money transfer services (e.g., PayPal), electronic wallet, digital currency (e.g., bitcoin, etc.), and the like.

In an alternative embodiment, credits are used to bid for the right to make a clinical trial enrollment offer to an individual. In further embodiments, clinical trial administrators participate in an auction-style competition to obtain the right to make a clinical trial enrollment offer to an individual. In still further embodiments, the auction-style competition is a reverse auction.

In some embodiments, clinical trial enrollment offers (apart from early offers) made to an individual accumulate and are presented to the individual, via the patient interface, after a predetermined period of time. In further embodiments, a suitable period of time is, for example, 1, 2, 3, 4, 5, 6, or more days. In other embodiments, a suitable period of time is, for example, 1, 2, 3, 4, 5, 6, or more weeks.

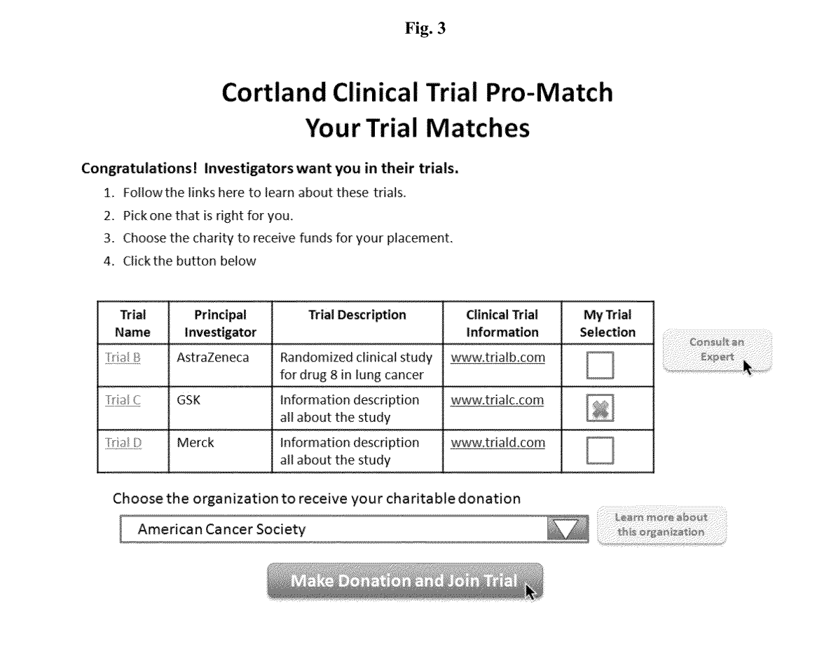

Referring to FIG. 3, in a particular embodiment, the platforms, systems, media, and methods described herein include a patient interface providing the individual patient with the ability to review clinical trail enrollment offers extended to them. In this embodiment, the interface further allows selection of trial (acceptance of an offer). In this embodiment, the patient interface includes a list of offers extended to the individual and presented at the end of a pre-determined time period. Further, in this example, for each offer the patient is provided, for example, the clinical trial name, the principal investigator (sponsor), a description of the clinical trial, and a link to a web site with further information on the clinical trial. Importantly, included in this exemplary interface, are features allowing the patient to optionally accept an offer, thus selecting a trial.

Continuing to refer to FIG. 3, in this embodiment, the interface includes features for allowing the patient to request a consultation with an expert, e.g., a medical professional with genomic medicine expertise, prior to selecting an offer/clinical trial. Further in this embodiment, the interface includes features for allowing the patient to select a recipient for a charitable donation. For example, where clinical trial sponsors (or clinical trial administrators) are required to obtain credits to make recruitment offers by making financial payments, the patient is optionally provided with an opportunity to determine where some or all of the financial proceeds are directed.

The inventions disclosed herein include business methods. In some embodiments, the platforms, systems, media, and methods disclosed herein are marketed, advertised, and sold as, for example, services for facilitating patient recruitment for clinical trials. In further embodiments, the services are offered as software-as-a-service (SaaS). The services disclosed herein are particularly well suited for enabling clinical trial sponsors and administrators to identify and communicate with suitable patient populations and providing a more cost-effective and timely methodology for recruiting patients for trials. The products and services disclosed herein are also well suited for providing a mechanism for suitable patients to identify areas of investigation where there is an unmet need for clinical trials. As described herein, in some embodiments, the platforms, systems, media, and methods disclosed herein include e-commerce features. In some embodiments, the e-commerce features support commerce with clinical trial sponsors and administrators, for example, to purchase credits used to extend recruitment offers or make bids. In other embodiments, the e-commerce features support commerce with patients, for example, to purchase consumer goods and services.

### Networking Features for Individuals

In some embodiments, the platforms, systems, media, and methods described herein include patient networking features, or use of the same. In further embodiments, the networking features utilize patient profiles to facilitate networking. In still further embodiments, the networking features utilize patient molecular phenotypes to facilitate networking. By way of example, in some embodiments, the platforms, systems, media, and methods described herein include features for allowing an individual to identify and communicate with other individuals with a similar profile, including molecular phenotype. By way of further example, in some embodiments, the platforms, systems, media, and methods described herein include features for allowing an individual to identify and communicate with a medical professional with genomic medicine expertise based on the individual's profile, including molecular phenotype.

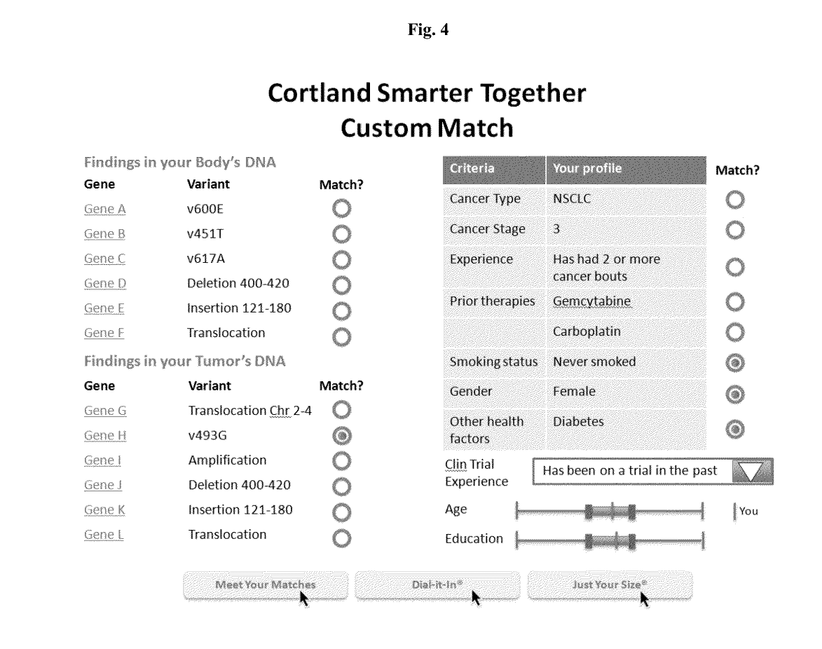

Referring to FIG. 4, in a particular embodiment, the platforms, systems, media, and methods described herein include a patient interface providing the individual patient with the ability to identify other individuals with similar profile information, including molecular phenotype information. In this embodiment, the patient is provided with information pertaining to genes associated with DNA from their non-tumor and tumor tissues. Further in this embodiment, the patient is provided with one or more variants for each gene (e.g., mutation, etc.). In this embodiment, the patient is provided with information pertaining to other aspects of their profile, for example, the patient's cancer type, cancer stage, residential location, prior therapeutic experience, prior therapies, prior clinical trial experience, smoking status, gender, comorbidities, and date of birth. Still further in this embodiment, the patient is provided with features to select which aspects of their profile and/or molecular phenotype on which to search for other individuals as well as features to adjust the degree of match desired.

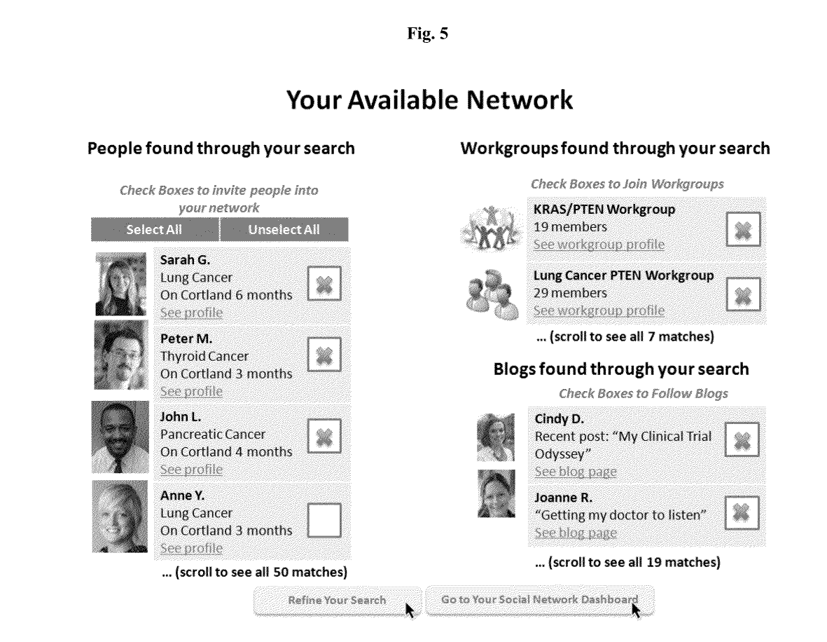

Referring to FIG. 5, in a particular embodiment, the platforms, systems, media, and methods described herein include a patient interface providing the individual patient with a list of other individuals, workgroups, and blogs identified based on profile information, including molecular phenotype information.

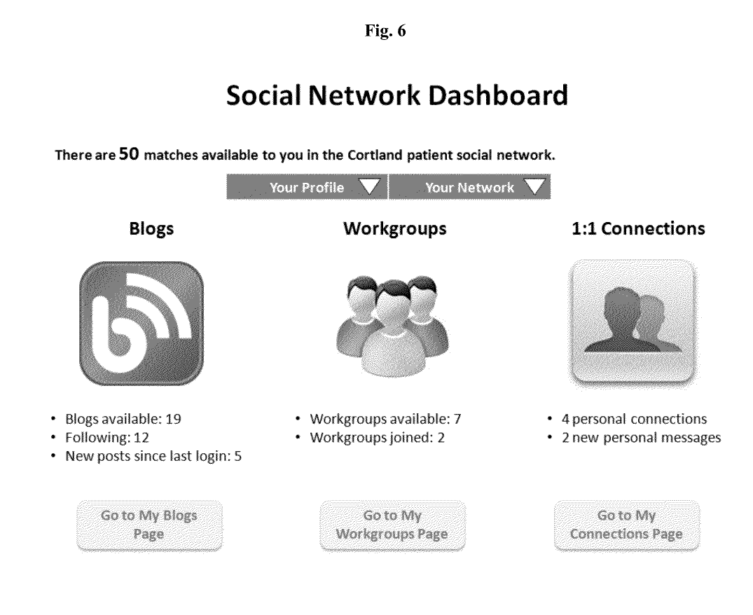

Referring to FIG. 6, in a particular embodiment, the platforms, systems, media, and methods described herein include a patient interface providing the individual patient with a dashboard of networking resources indentified based on their profile information, including their molecular phenotype information.

In some embodiments, the platforms, systems, media, and methods described herein include features for conducting consumer e-commerce with patients. In further embodiments, the e-commerce features allow patients to purchase consumer products including, for example, over-the-counter (OTC) medications, supplements, vitamins, literature, and the like. In a particular embodiment, the features for conducting consumer e-commerce with patients offer one or more market baskets of products based on molecular phenotype, e.g., a “genetic shopping cart.” In such embodiments, products and services are identified for a particular patient based on their molecular phenotype and are constantly updated based on changes to their genetic profile.

In some embodiments, the platforms, systems, media, and methods described herein include features for allowing a patient to identify treatment options based on their profile, including their molecular phenotype. In further embodiments, a feature for allowing a patient to identify treatment options allows the patient to identify suitable clinical trials open for enrollment. In still further embodiments, the patient identifies relevant and available clinical trials to which they may apply, the relevance based on their profile, including molecular phenotype. In some embodiments, the platforms, systems, media, and methods described herein include features for allowing a patient to express their interest in participation in a clinical trial.

### Crowdsourced Clinical Trials

In some embodiments, the platforms, systems, media, and methods described herein include features for allowing a patient to volunteer as a subject in a suitable proposed clinical trial, or use of the same. In further embodiments, the proposed clinical trial is for a therapy, such as a drug, matched to the patient based on their molecular phenotype. In still further embodiments, the proposed clinical trial is for a drug where insufficient medical evidence currently exists to support use of the drug as a therapy for a condition associated with the patient's molecular phenotype.

In some embodiments, the platforms, systems, media, and methods described herein include features for allowing a patient to review the degree of existing medical evidence supporting use of matched drugs as a therapy for one or more conditions indicated by their profile. In further embodiments, the platforms, systems, media, and methods described herein include features for allowing a patient to register their desire to volunteer as a subject in a suitable proposed clinical trial. In still further embodiments, the platforms, systems, media, and methods described herein assemble cohorts of individuals similarly volunteering as subjects in a proposed clinical trial for a drug. In some embodiments, the platforms, systems, media, and methods described herein include features for allowing a drug product manager to review an assembled cohort of individuals volunteering as subjects in a proposed clinical trial for a drug managed by the drug product manager.

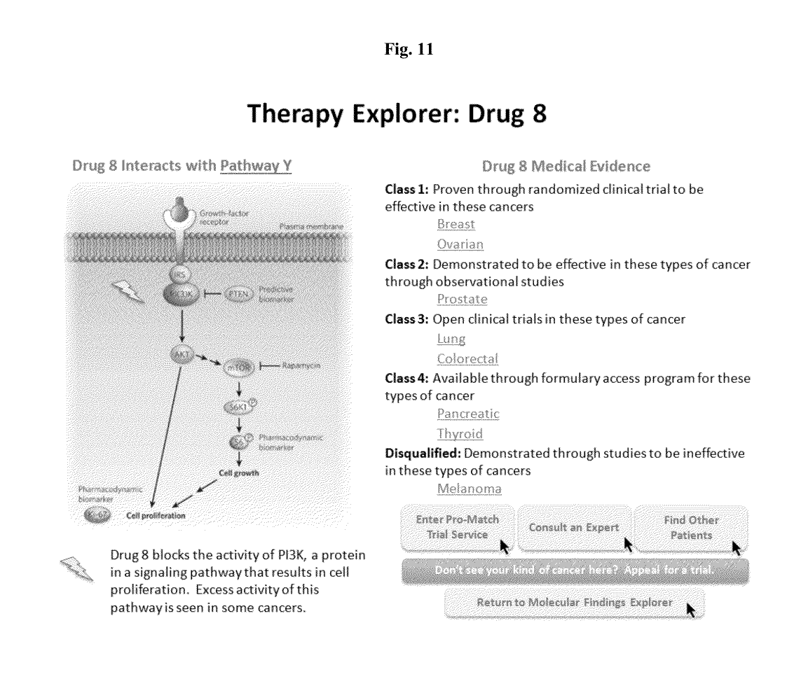

Referring to FIG. 11, in a particular embodiment, the platforms, systems, media, and methods described herein include a patient interface providing the patient with a “therapy explorer” allowing the patient to learn about drugs and other therapies relevant to particular aspects of their molecular phenotype. In this embodiment, the patient interface allows the patient to review the degree of medical evidence supporting use of a drug as a therapy for a condition indicated by their profile. Further, in this embodiment, the degree of medical evidence includes, by way of non-limiting examples, demonstrated effective through a randomized clinical trial, demonstrated effective in an observational study, open clinical trial underway, and demonstrated ineffective. In this embodiment, the patient interface allows a patient to volunteer as a subject in a suitable proposed clinical trial where current medical evidence is insufficient to support use of the drug as a therapy for a condition associated with the patient's molecular phenotype

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of clinical trial, profile, and/or molecular phenotype information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented suite of electronic interfaces for use by patients and clinical trial administrators on an electronic molecular-phenotype driven, clinical trial recruitment platform comprising: a digital processing device comprising an operating system configured to perform executable instructions and a memory device; and a computer program including instructions executable by the digital processing device to create an application comprising:
a. a software module configured to present an interface for allowing an individual to post a profile to a secure online marketplace for a defined duration, for the purpose of being recruited to clinical trials;
b. a database of profiles, each profile comprising:
i. personal information, the personal information configured by the individual; and
ii. a molecular phenotype for the individual, the molecular phenotype determined by medical diagnostic testing performed at a qualified facility;
c. a software module configured to execute automated direct transfer, on demand by the individual or their authorized healthcare representative, of molecular profiling diagnostic test results from a first storage at the qualified facility to a second storage accessible by the application;
d. a software module configured to present an interface for allowing a clinical trial administrator to establish a search for the purpose of identifying individuals eligible for enrollment by entering clinical trial patient inclusion and exclusion criteria comprising a molecular phenotype;
e. a software module configured to present an interface for allowing the clinical trial administrator to identify individuals eligible for the clinical trial, from among active posted profiles, based on comparison of the individual-posted profiles and the criteria;
f. a software module configured to present an interface for allowing the clinical trial administrator to receive notifications when new individuals post a profile to the online marketplace and review profile information for identified individuals;
g. a software module configured to present an interface for allowing a clinical trial administrator to make clinical trial enrollment offers to identified individuals, the enrollment offers comprising an invitation or presentation of opportunity to enroll in the clinical trial;
h. a software module configured to present offers made to an individual or their authorized healthcare representative, the individual the subject of the offers;
i. a software module configured to present an interface for allowing the individual or the authorized healthcare representative to select an offer from among the presented offers; and
j. a software module configured to present an interface for allowing the clinical trial administrator to monitor clinical trial enrollment information, the clinical trial enrollment information comprising: status of open offers of enrollment and individuals available for enrollment in the clinical trial.

2. The system of claim 1, wherein the application further comprises a database of profiles, each profile comprising a molecular phenotype for an individual.

3. The system of claim 1, wherein the molecular phenotype comprises DNA sequence information, the DNA sequence information comprising two or more genes and two or more variants or mutations.

4. The system of claim 1, wherein the application further comprises a software module configured to conduct e-commerce with an individual, the commerce including goods identified by the application or other individuals based on the individual's profile, the profile comprising a molecular phenotype.

5. The system of claim 1, wherein making a clinical trial enrollment offer requires a transaction by the clinical trial administrator.

6. The system of claim 1, wherein the software module configured to present an interface for allowing a clinical trial administrator to make clinical trial enrollment offers allows the administrator to optionally make an early offer.

7. The system of claim 1, wherein the software module configured to present clinical trial enrollment offers accumulates offers made and presents them to the individual after a predetermined period of time.

8. The system of claim 1, wherein the application further comprises a software module configured to present an interface for allowing an individual to identify and communicate with other individuals with a similar profile, including molecular phenotype.

9. The system of claim 1, wherein the application further comprises a software module configured to present an interface for allowing an individual to identify one or more treatment options based on their profile, including molecular phenotype.

10. The system of claim 1, wherein the application further comprises a software module configured to present an interface for allowing an individual to identify one or more relevant and available clinical trials to which they may apply, the relevance based on their profile, including molecular phenotype.

11. The system of claim 1, wherein the application further comprises a software module configured to present an interface for allowing an individual to identify and communicate with a medical professional with genomic medicine expertise based on the individual's profile, including molecular phenotype.

12. The system of claim 1, wherein the software module configured to present an interface for allowing the clinical trial administrator to receive and review profile information for identified individuals provides profile information for the duration of the search.

13. A computer-implemented suite of electronic interfaces for use by patients and clinical trial administrators on an electronic molecular-phenotype driven, clinical trial recruitment platform comprising: a digital processing device comprising an operating system configured to perform executable instructions and a memory device; and a computer program including instructions executable by the digital processing device to create an application comprising:
a. a software module configured to present an interface for allowing an individual or their authorized healthcare representative to post a profile to a secure online marketplace for a defined duration, for the purpose of being recruited to clinical trials, the profile comprising:
i. personal information, the personal information configured by a subject individual; and
ii. a molecular phenotype for the individual, the molecular phenotype determined by medical diagnostic testing performed at a qualified facility;
b. a software module configured to execute automated direct transfer, on demand by the individual or their authorized healthcare representative, of molecular profiling diagnostic test results from a first storage at the qualified facility to a second storage accessible by the application;
c. a software module configured to present one or more clinical trial enrollment offers made to the individual or their authorized healthcare representative, the one or more clinical trial enrollment offers comprising an invitation or presentation of opportunity to enroll in the clinical trial, the one or more clinical trial enrollment offers made by clinical trial administrators based on the profile, including the molecular phenotype; and
d. a software module configured to allow the individual or their authorized healthcare representative to select a clinical trial enrollment offer from among the presented one or more clinical trial enrollment offers.

14. The system of claim 13, wherein the molecular phenotype comprises DNA sequence information, the DNA sequence information comprising two or more genes and two or more variants or mutations.

15. A computer-implemented suite of electronic interfaces for use by patients and clinical trial administrators on an electronic molecular-phenotype driven, clinical trial recruitment platform comprising: a digital processing device comprising an operating system configured to perform executable instructions and a memory device; and a computer program including instructions executable by the digital processing device to create an application comprising:
a. a software module configured to allow a clinical trial administrator to establish a search for the purpose of identifying individuals eligible for enrollment by entering clinical trial patient inclusion and exclusion criteria comprising a molecular phenotype;
b. a software module configured to allow the clinical trial administrator to identify individuals eligible for the clinical trial from among active individual-posted profiles based on comparison of the criteria and individual profiles, each profile posted to a secure online marketplace for a defined duration, for the purpose of being recruited to clinical trials, each profile comprising:
i. personal information, the personal information configured by a subject individual; and
ii. a molecular phenotype for the individual, the molecular phenotype determined by medical diagnostic testing performed at a qualified facility, the molecular phenotype obtained by automated direct transfer of molecular profiling diagnostic test results from a first storage at the qualified facility to a second storage accessible by the application, the transfer executed on demand by the individual or their authorized healthcare representative;
c. a software module configured to allow the clinical trial administrator to make clinical trial enrollment offers to identified individuals, the enrollment offers comprising an invitation or presentation of opportunity to enroll in the clinical trial;
d. a software module configured to receive a selection of an offer from each individual or their authorized healthcare representative, the individual the subject of at least one offer; and
e. a software module configured to present an interface for allowing the clinical trial administrator to monitor clinical trial enrollment information, the clinical trial enrollment information comprising: status of open offers of enrollment and individuals available for enrollment in the clinical trial.

16. The system of claim 15, wherein the molecular phenotype comprises DNA sequence information, the DNA sequence information comprising two or more genes and two or more variants or mutations.

17. (canceled)

18. (canceled)

19. (canceled)

20. (canceled)

21. The system of claim 3, wherein the DNA sequence information comprises chemical modifications that are measured in normal or diseased tissue.

22. The system of claim 5, wherein the transaction requires a fee incurred at the time the offer is made or accepted or at the time an enrollment is consummated.

23. The system of claim 1, wherein the software module configured to present an interface for allowing the individual or the authorized healthcare representative to select an offer from among the presented offers allows selection during a predetermined period of time.

24. (canceled)

25. (canceled)

26. (canceled)

27. (canceled)

28. (canceled)

29. (canceled)

30. The system of claim 1, wherein the automated direct transfer of the molecular profiling diagnostic test results is executed without identity authentication.

31. The system of claim 13, wherein the automated direct transfer of the molecular profiling diagnostic test results is executed without identity authentication.

32. The system of claim 15, wherein the automated direct transfer of the molecular profiling diagnostic test results is executed without identity authentication.
